(19) United States
(12) Patent Application Publication
(10) Pub. No.: US 2008/0055884 A1
(43) Pub. Date: Mar. 6, 2008

(54) DEVICE AND METHOD FOR ILLUMINATING A FLUID

(76) Inventors: Robert J. Victor, Sunnyside, NY (US); Bernadette Evangelist, New York, NY (US)

Correspondence Address: PETER J. RASHID, 5111 MOUNTAIN ROAD, BRIGHTON, MI, 48116-9735, US

(21) Appl. No.: 11/843,895

(22) Filed: Aug. 23, 2007

Related U.S. Application Data
(60) Provisional application No. 60/841,083, filed on Aug. 30, 2006.

(51) Int. Cl. F21V 33/00

(52) U.S. Cl. 362/96

(57) ABSTRACT

A device and method for illuminating a fluid is disclosed. The device includes a closed, collapsible container for holding a fluid and having an outlet, a light source for illuminating the fluid being dispensed through the outlet, and a switching mechanism for activating the light source in response to an external event, such as a change in pressure within the container, fluid pressure, and the like. The container may be a portable, hand-held container, such as a toothpaste dispenser, shampoo container, and the like.

### FIELD OF THE INVENTION

The present invention relates generally to illumination devices, and more specifically to devices that illuminate a fluid that is dispensed from a collapsible, closed container

### BACKGROUND OF THE INVENTION

It is well known that a column of transparent fluid acts as a light pipe when a light source is directed axially into it. Such a column will conduct light through its interior in much the same way that a fiber optic cable does, in an effect known as total internal reflection. Unlike a fiber optic cable however, a typical fluid column contains ripples, voids, and other imperfections throughout its interior. As a result, some light is scattered outward rather than being conducted through it. This scattered light causes the fluid column itself to glow.

This effect has been employed to create illuminated water fountains that appear to project arcing beams of light into the air. An example of such a device is described in U.S. Pat. No. 6,076,741. This effect has also been used to illuminate a stream of water as it emerges from a plumbing fixture such as a bathroom faucet, as disclosed in US Published Application No. 2004/0258567A1, and has similarly been used to illuminate a beverage emerging from a tap.

Furthermore, this effect has been used to illuminate the interior of a container so that the fluid within becomes luminescent, as shown in U.S. Pat. Nos. 6,352,352 and 6,254,247 and U.S. Published Application No. 2003/0137827A1.

Therefore, it is clear that many devices exist that will illuminate a stream of fluid being projected from a fixture, and likewise, that cause a static body a fluid within a vessel to glow. However, none of these devices are intended to cause a column of fluid to glow when dispensed from a hand-held, collapsible closed container.

### SUMMARY OF THE INVENTION

Many everyday activities, such as grooming and brushing teeth, involve the use of transparent or semi-transparent fluids. These fluids are frequently dispensed into the hand or onto some implement, from a container. There would be considerable utility and novelty value in rendering such fluids luminescent while they were being dispensed, so that, for example, a line of toothpaste could glow while being applied to a tooth brush, or a pool of hair gel could glow while being dispensed into the palm.

It is therefore an aspect of the invention to provide a general and widely adaptable container that can render a fluid luminescent during the dispensing process, with the dispensing process being defined as the state in which the fluid is external to, yet still in contact with, the outlet of the dispensing container.

The invention is an illuminated fluid dispensing container which conducts light through the dispensed fluid using the effect of total internal reflection, whenever a continuous column of fluid exists between the outlet of the container and the fluid already dispensed. The invention thereby renders the dispensed fluid luminescent. In effect, the device uses the dispensed fluid to form what is commonly known as a “light pipe”.

The light source may be located within the container or outside of the container. If the light source is located outside of the container, a reflective conduit is used to conduct the light to the interior of the container.

The light source may be either electrical or chemical. Where the light source is electrical, a switch may be provided to activate the light while the fluid is being dispensed.

The device may function using any clear, or semi-clear fluid, including solutions, suspensions, gels, and slurries.

The essential elements of the device include a light source, power for the light source, and a means for activating the light source while fluid is being dispensed. The device primarily resides at, or near, the outlet of a container. While the presence of a container is not essential to the function of the device, all descriptions of the invention are made in context of the device being used in conjunction with a closed container. This container dispenses the fluid that is subsequently illuminated.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of the preferred embodiment of the invention.

FIG. 2 is a side view schematic showing the position of the light source relative to the container.

FIG. 3 is a side view schematic showing an alternative position for the light source.

FIG. 4 is a side view schematic showing yet another position for the light source.

### DETAILED DESCRIPTION OF THE PREFERRED EMBODIMENTS

The following description of the preferred embodiment(s) is merely exemplary in nature and is in no way intended to limit the invention, its application, or uses.

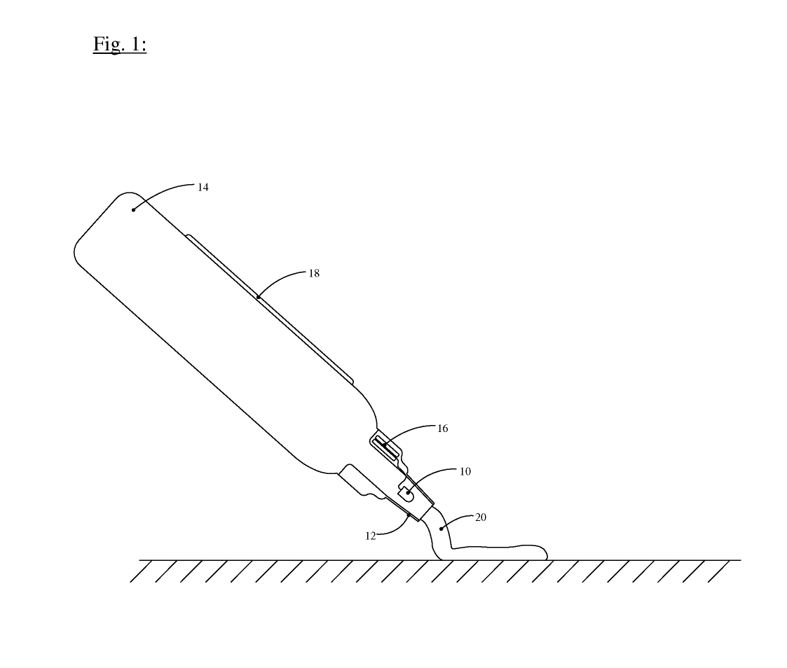

Referring now to FIG. 1, the device uses a light source 10, such as a high-intensity LED. The light source 10 is located near an outlet 12 of a container 14, and is positioned so that light source 10 projects light generally toward the outlet 12. The light source 10 is powered by a power source 16, such as a battery, and the like. In one embodiment, electrical current from the battery 16 is controlled by a pressure sensitive tape switch 18.

In operation, the LED 10, or other light source, emits light when fluid is being dispensed from the container 14, and not during other times, such as when the container 14 is being stored. In one embodiment, the pressure sensitive tape switch 18 is attached to the wall of the container 14 in such a location that the switch 18 is placed in a closed state when the container 14 is grasped or squeezed with the hand, thereby activating the light source 10. In another embodiment, the light source 10 may be activated via a pressure sensitive switch located within the closed container 14 to sense a change of pressure within the closed container 14 due to the user squeezing the container 14. Once the user releases the container 14, the pressure in the container 14 will reach an equilibrium pressure state and the light source 10 will be deactivated.

Once the fluid 20 has begun to flow from the container's outlet 12, the light rays emitted from the LED 10 are conducted through the interior of the fluid 20 by the effect of total internal reflection. Due to the light-scattering effect noted previously, the fluid column subsequently becomes luminescent, or glows, for some distance after exiting the container 14. The actual length of fluid 20 that may be illuminated in this way depends on the intensity of the LED 10 and the transparency of the fluid 20.

In an embodiment, the fluid 20 is in direct contact with the LED 10, and flows around the LED 10. Because LEDs are hermetically sealed against moisture during manufacture, fluid contamination is not a concern. However, if desired, the LED 10 and its wires may be encased in a clear plastic sheath with little effect on light transmission.

It is important to note that light does not simply project straight outward from the container as with a flashlight. Instead, the majority of the light is captured by the fluid column as the light emerges from the outlet 12 of the container 14, and is bent to follow the path of the fluid 20, thereby creating the illusion that the fluid 20 emerging from the container 14 is glowing. This effect may be sustained as long as the column of fluid is in contact with the outlet 12 of the container 14.

### Alternative Embodiments

As noted previously, it is preferable that the light source 10 is only active during the time that fluid 20 is being dispensed from the container 14. While it is currently believed that the most economical and effective way to achieve this by using a pressure sensitive switch 18 on the wall of the container 14, there are other means of activating the light source 10 during the dispensing process which may later be adopted as an alternate embodiment of the invention. Some of these alternate embodiments are described below.

Tilt Sensor

Since it may safely be assumed that the user will tilt the container downward while dispensing fluid, it may be preferable to use a tilt sensor to control the light source 10. This sensor would activate the light source 10 when the container 14 was tilted some degree past horizontal. A means would be necessary to deactivate the sensor during transportation of the container 14.

Activation Upon Removal of a Cap

Nearly all fluid containers require that some sort of closure or cap be removed prior to dispensing their contents. It may be preferable use this action to also activate the light source 10. This can be accomplished by linking an electrical switch to the cap so that it closes when the cap is removed and opens when the cap is replaced.

Manual Activation by Momentary Button or Switch

It may be sufficient to simply require the user to manually hold down a momentary button or switch while the container was being used.

Hydrostatic Pressure Sensor

When dispensing highly viscous fluids such as toothpaste, it is necessary to squeeze the container 14. The resulting increase in hydrostatic pressure within the container 14 can be detected with a pressure sensor, which could activate the light source 10.

Other means may exist to activate the light source 10 during the dispensing process, and this description is not intended to limit the invention to any particular mechanism.

Location of the Light Source

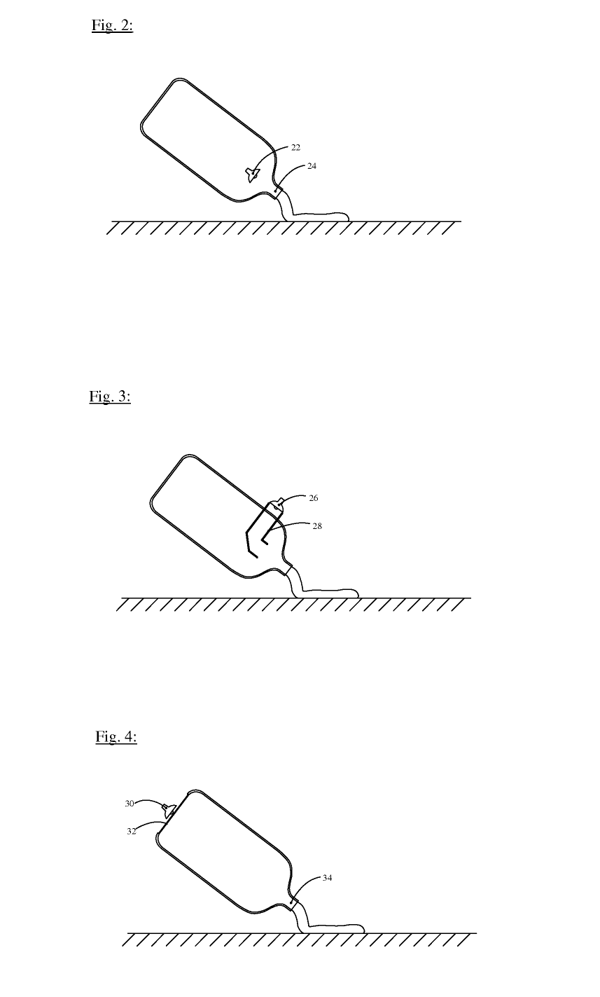

As mentioned previously, the preferred embodiment puts the fluid in direct contact with the LED 10, which is immersed in the fluid stream. This configuration is illustrated by FIG. 2. Here, a generic light source 22 is located within a container 14, and directs its light generally toward the container's outlet 24.

Alternatively, as shown in FIG. 3, the light source 26 may be located outside of the container 14, with the light rays being conducted into the container 14 through a reflective or conductive structure 28.

Yet another method for implemented an external light source is shown in FIG. 4. Here, the light source 30 projects through a clear window 32 located behind the outlet 34 of the container.

It can readily be shown that the essential function of this invention does not rely on the specific means by which light is generated. Therefore, this invention should not be limited to using a Light Emitting Diode (LED), but instead may function equally well with an incandescent, fluorescent, or other type of electric lamp. Furthermore, this invention is not limited to using an electrically powered light, but may employ a chemically powered light source as well.

Other Operational Considerations:

Due to the wet environment in which the invention will likely be used, it is preferable that the electronic system be sealed. To facilitate this, it may be preferable to employ a non-opening battery compartment, in which case the device would be disposed of when the batteries were exhausted.

It may be determined that it is more practical to market the invention as an accessory designed to fit onto an existing container, rather than as a complete dispensing system. This may be preferable with a product such as toothpaste, where many manufactures use a common closure or cap size. In this case, the invention would take the form of a large cap that would contain all the components necessary to power and activate the light.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device for illuminating a fluid, comprising:
a container for holding a fluid, said container having an outlet;
a light source for illuminating the fluid being dispensed through said outlet of said container; and
means for activating said light source.

2. A device according to claim 1, wherein said container comprises a collapsible, closed container.

3. A device according to claim 2, wherein said light source is activated by sensing a change of pressure within said container.

4. A device according to claim 1, wherein said activating means comprises a manually-activated switch.

5. A device according to claim 1, wherein said activating means comprises a hydrostatic pressure sensor.

6. A device according to claim 1, wherein said container comprises a portable, hand-held container.

7. A device according to claim 6, wherein said portable, hand-held container comprises a toothpaste container.

8. A device according to claim 1, wherein said light source comprises a LED.

9. A device according to claim 1, wherein said light source comprises a generic light source disposed within said container.

10. A device according to claim 1, wherein said activating means comprises a pressure sensitive tape switch.

11. A device according to claim 10, wherein said pressure sensitive tape switch is located on a wall of said container.

12. A device according to claim 1, wherein said light source is located inside said container.

13. A device according to claim 1, wherein said light source is located outside said container.

14. A device according to claim 13, wherein the light rays are conducted into said container through a reflective or conductive structure.
